(19) United States
(12) Patent Application Publication
(10) Pub. No.: US 2024/0151738 A1
(43) Pub. Date: May 9, 2024

(54) SPECIMEN CONTAINER RACKS AND RELATED METHODS

(71) Applicant: Ben Lee, Corona, CA (US)

(72) Inventor: Ben Lee, Corona, CA (US)

(21) Appl. No.: 17/984,094

(22) Filed: Nov. 9, 2022

(51) Int. Cl. G01N 35/04; B01L 9/06

(52) U.S. Cl. CPC G01N 35/04; B01L 9/06; G01N 2035/0412; G01N 2035/0498

(57) ABSTRACT

A rack and lid for specimen containers is disclosed. The rack can include a top portion, a support, and a top portion. The top portion can include one or more clips configured to receive a specimen container. The rack can be configured to prevent the specimen containers from shifting and/or being damaged during transit. Other embodiments are disclosed herein.

### TECHNICAL FIELD

This disclosure relates generally to item racks and more specifically to racks for specimen containers.

### BACKGROUND

Shipping of items across the world has become increasingly important to many organizations and individuals. Items that are shipped often need to be packed so that they are not damaged during transit. Oftentimes various void fill materials are used to cushion items against the jolts and jostles associated with shipping. For example, bubble wrap, air pillows, packing peanuts, and crumpled paper are all common void fill materials. These materials, though, can be ineffective when used for shipments of specimen containers because the containers can still tip over and move about in the void fill. These problems with void fill materials can be compounded when the shipped item requires a temperature-controlled environment. For example, air cushioned void fill (e.g., bubble wrap and/or air pillows) can deflate due to their loss of internal pressure at low temperatures. As another example, packing peanuts and crumpled paper can become rigid and fragile, thereby losing their cushioning properties.

Therefore, in view of the above, there is a need for an improved rack for specimen containers.

### SUMMARY

A rack for a specimen container is provided. The rack can comprise a base portion configured to receive a bottom end of the specimen container. The rack can comprise a support having a first end coupled to the base portion. The rack can comprise a top portion coupled to a second end of the support, the top portion configured to receive a second portion of the specimen container extending away from the bottom end of the specimen container.

In some embodiments, the base portion and the top portion can be configured to, after receiving the bottom end of the specimen container and the second portion of the specimen container, respectively, prevent the specimen container from tipping over.

In many embodiments, the base portion can comprise a bowl.

In various embodiments, the specimen container can comprise a biological sample container.

In further embodiments, the base portion can comprise a first portion of a locking mechanism configured to removably couple a lid onto the rack.

In some embodiments, the base portion can comprise a lip around a perimeter of the base portion. The first portion of the locking mechanism can comprise a groove formed on an exterior surface of the lip. A second portion of the locking mechanism comprises a nub coupled to an interior surface of the lid.

In many embodiments, the rack can comprise a lid, which can comprise a handle. The base portion can comprise an indent formed on a bottom surface of the base portion. The indent can be configured to receive the handle, thereby allowing a plurality of racks to be stacked.

A method of providing a rack for a specimen container is provided. The method can comprise providing a base portion of the rack. The base portion can be configured to receive a bottom end of the specimen container. The method can comprise providing a support having a first end coupled to the base portion. The method can comprise providing a top portion of the rack coupled to a second end of the support. The top portion can be configured to receive a second portion of the specimen container extending away from the bottom end of the specimen container.

In some embodiments, the base portion and the top portion can be configured to, after receiving the bottom end of the specimen container and the second portion of the specimen container, respectively, prevent the specimen container from tipping over.

In many embodiments, providing the base portion can comprise providing a bowl.

In various embodiments, the specimen container can comprise a biological sample container.

In further embodiments, providing the base portion can comprise providing a first portion of a locking mechanism configured to removably couple a lid onto the rack.

In some embodiments, providing the base portion can comprise providing a lip around a perimeter of the base portion. The first portion of the locking mechanism can comprise a groove formed on an exterior surface of the lip. A second portion of the locking mechanism comprises a nub coupled to an interior surface of the lid.

In many embodiments, the method can comprise providing a lid, which can comprise a handle. Providing the base portion can comprise providing the base portion comprising an indent formed on a bottom surface of the base portion. The indent can be configured to receive the handle, thereby allowing a plurality of racks to be stacked.

A method of using a rack for a specimen container is provided. The method can comprise inserting a bottom portion of the specimen container into a base portion of the rack. The method can comprise inserting a second portion of the specimen container extending away from the bottom end of the specimen container into a top portion of the rack. The base portion can be coupled to a first end of a support. The top portion can be coupled to a second end of the support.

In some embodiments, the base portion and the top portion can be configured to, after receiving the bottom end of the specimen container and the second portion of the specimen container, respectively, prevent the specimen container from tipping over.

In many embodiments, the base portion can comprise a bowl.

In various embodiments, the specimen container can comprise a biological sample container.

In some embodiments, inserting the second portion of the specimen container into the top portion of the rack can comprise inserting the second portion of the specimen container into a clip coupled to the top portion of the rack.

In many embodiments, the base portion can comprise a first portion of a locking mechanism. The method can comprise after inserting the bottom portion of the specimen container and the second portion of the specimen container into the rack, coupling the first portion of the locking mechanism to a second portion of the locking mechanism coupled to a lid.

In further embodiments, the base portion comprises an indent formed on a bottom surface of the base portion. The method can comprise placing the rack on top of a second rack for a second specimen container by inserting a handle of a lid of the second rack into the indent of the base portion.

### BRIEF DESCRIPTION OF THE DRAWINGS

To facilitate further description of the embodiments, the following drawings are provided in which:

FIG. 1A illustrates an isometric view of an exemplary rack;

FIG. 1B illustrates top down view of an exemplary rack;

FIG. 2 illustrates an isometric view of an exemplary lid for a rack;

FIG. 3 illustrates an exemplary cross sectional view of an exemplary rack and lid system;

FIG. 4 illustrates an isometric view of an exemplary lid and rack system;

FIG. 5 illustrates a cross sectional view of an exemplary lid, rack, and dewar system;

FIG. 6 illustrates a cross sectional view of an exemplary stacked rack and lid system;

FIG. 7 illustrates a cross sectional view of an exemplary stacked rack, lid, and dewar system;

FIG. 8 illustrates an isometric view of an exemplary lid and rack system;

FIG. 9 illustrates an isometric view of an exemplary stacked rack and lid system;

FIG. 10 illustrates a cross sectional view of an exemplary stacked rack, lid, and dewar system;

FIG. 11 illustrates an exemplary method for providing an exemplary rack and lid; and

FIG. 12 illustrates an exemplary method of using an exemplary rack and lid.

For simplicity and clarity of illustration, the drawing figures illustrate the general manner of construction, and descriptions and details of well-known features and techniques may be omitted to avoid unnecessarily obscuring the present disclosure. Additionally, elements in the drawing figures are not necessarily drawn to scale. For example, the dimensions of some of the elements in the figures may be exaggerated relative to other elements to help improve understanding of embodiments of the present disclosure. The same reference numerals in different figures denote the same elements.

### DETAILED DESCRIPTION

The cold chain can be considered a subset of the overall supply chain and can generally be described as a low temperature shipping network. The cold chain can be useful in shipping temperature sensitive foods, medical substances, and scientific research materials by preventing them from becoming spoiled or degraded during transit. An unbroken cold chain can generally be described as an uninterrupted series of refrigerated production, storage and distribution activities, along with the associated equipment and logistics, that maintain the shipment in the desired low-temperature range. The need for a successful and thriving cold chain has never been more apparent.

Many containers for specimens transported via the cold chain are ill equipped for the coarseness of the shipping process. Oftentimes, packages are jostled, tossed, stored sideways or upside down, crushed, or subjected to any number of potentially damaging forces. While various void fill materials can be used to cushion the contents of packages, these traditional approaches function poorly in the cold chain. Therefore, disclosed herein is a novel rack that can be used to both protect, insulate, and hold upright items shipped within it.

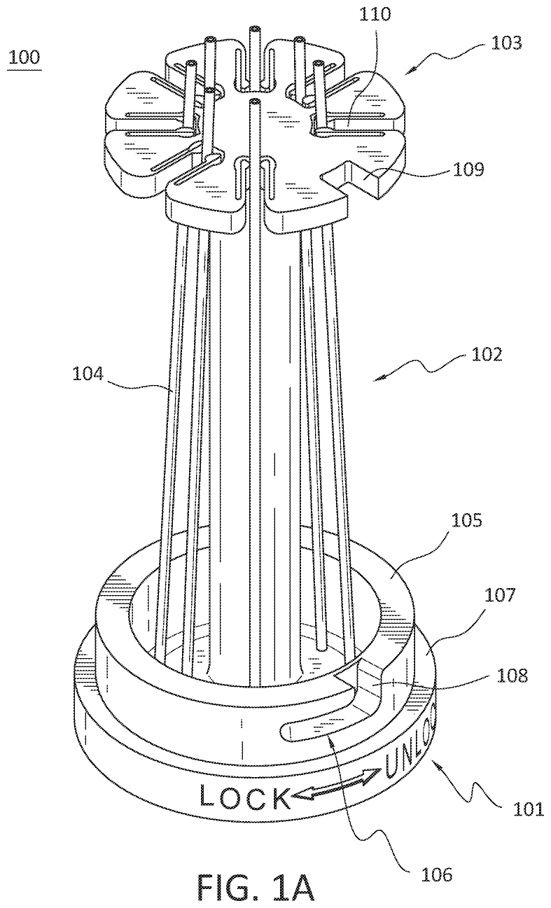

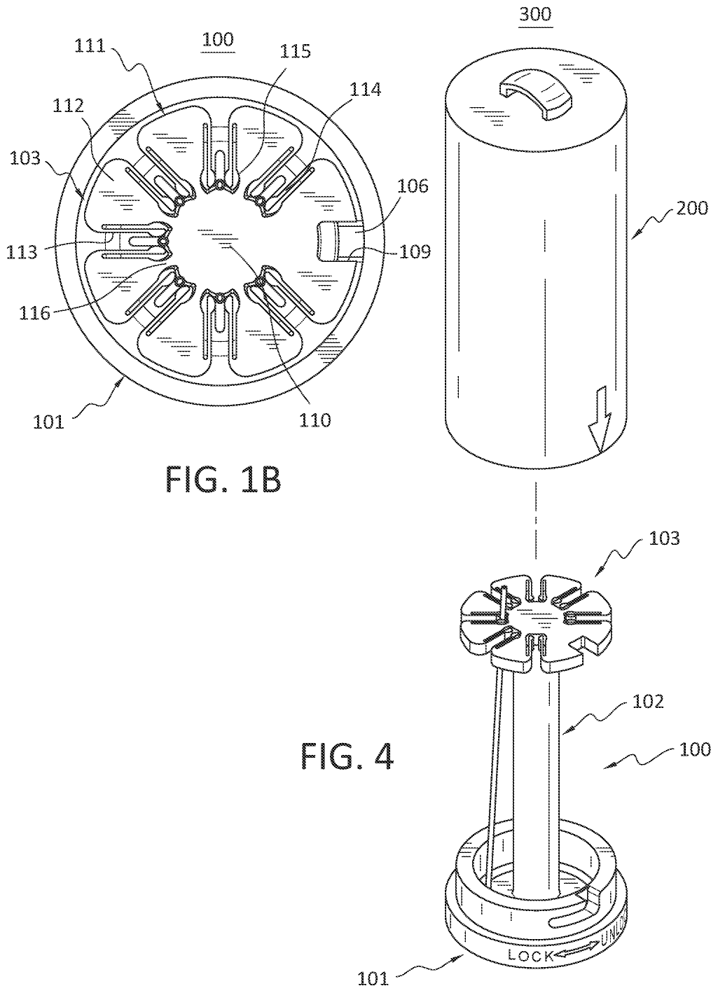

Turning to the drawings, FIG. 1A illustrates an exemplary rack 100. Generally speaking, rack 100 can be made from a variety of different materials. For example, rack 100 can be made of metal, wood, plastic, ceramic, and/or some other rigid or semi-rigid material. In many embodiments, rack 100 can comprise a base portion 101, a support 102, and/or a top portion 103. While not necessarily a part of rack 100, FIG. 1A also show a specimen container 104. In many embodiments, specimen container 104 can comprise an approximately cylindrical container. While specimen container 104 is shown in FIG. 1A as a straw, a number of different containers can be used. For example, a specimen container can comprise a test tube, beaker, a flask, a bottle, ajar, an Eppendorf tube, a vial, a cuvette, a centrifuge tube, a nuclear magnetic resonance (NMR) tube, a thistle tube, a Thiele tube, a pipette, a burette, etc. In these or other embodiments, a specimen container can be configured to withstand cold temperatures without deforming or shattering. For example, a specimen container can comprise a cryopreservation straw configured to withstand submersion in a cryogen (e.g., temperatures in the subzero range).

In some embodiments, base portion 101 can have a polygonal cross section. For example, base portion 101 can have a triangular cross section, a circular cross section, a semi-circular cross section, a square cross section, a rectangular cross section, a rhomboid cross section, a trapezoidal cross section, or any other polygonal cross section. In various embodiments, base portion 101 can be configured to receive a bottom end of specimen container 104. In some embodiments, base portion 101 can comprise a lip 105. In further embodiments, lip 105 can be located around a perimeter of base portion 101. In this way, a bottom end of specimen container 104 can be stopped by lip 105 before the bottom end falls off base portion 101. In many embodiments, lip 105 can be angled outward relative to the support 102 so that a bottom portion of specimen container 104 can be placed on an interior surface of lip 105. For example, lip 105 can create an obtuse angle with a floor of base portion 101. In this way, specimen container 104 may be placed at different angles relative to support 102, thereby allowing for different sized containers to be used with rack 100. In some embodiments, lip 105 can be angled inward so that specimen container 104 can be secured in place by lip 105. In these or other embodiments, base portion 101 can comprise a bowl having a hemispherical shape and lip 105 can have a partially arcuate cross section.

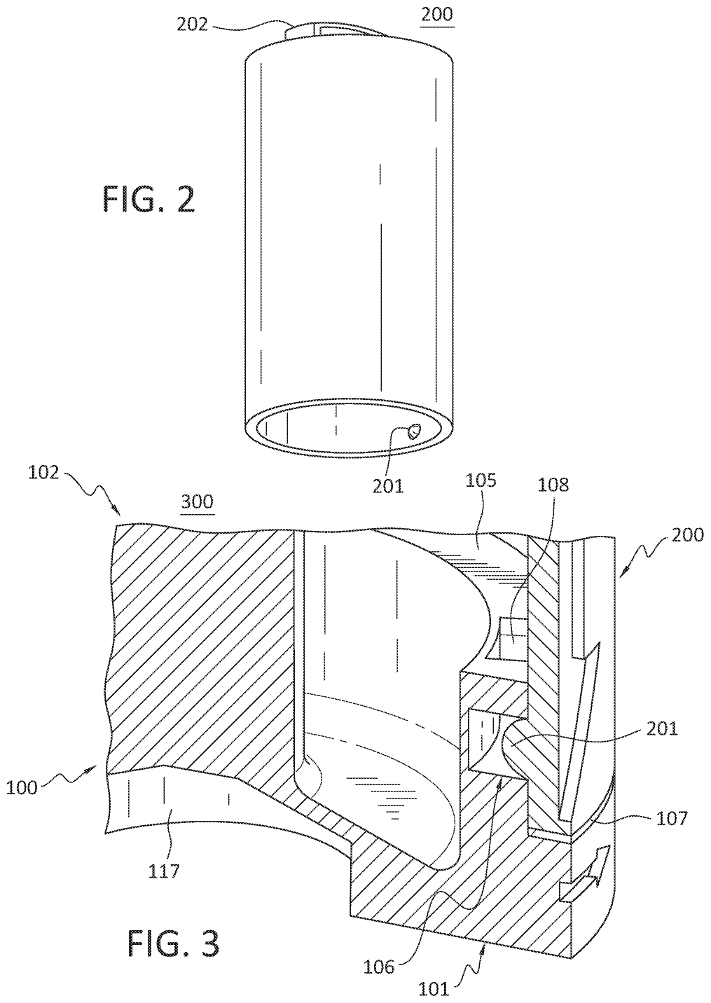

In many embodiments, base portion 101 can comprise a first portion of a locking mechanism 106 and/or a lid rest 107. In various embodiments, first portion of a locking mechanism 106 can be embedded in, integral with, and/or formed on an outer or an inner surface of lip 105. In some embodiments, first portion of a locking mechanism 106 can be configured to receive a second portion of a locking mechanism 201 (FIG. 2). After first portion of the locking mechanism 106 has received the second portion of the locking mechanism, a locking action can be performed to removably couple a lid 200 (FIG. 2) onto rack 100. In this way, the lid 200 (FIG. 2) can protect specimen container 104 from breakage, tipping, and deleterious elements that may be in the environment. In various embodiments, first portion of the locking mechanism 106 can comprise a groove 108 formed on lip 105. In these or other embodiments, the groove 108 is formed on an exterior surface of lip 105. For example, the groove 108 can be formed on a side exterior surface, and/or a top exterior surface.

In many embodiments, the support 102 can extend from the base portion 101 to the top portion 103. In some embodiments, the support 102 can be coupled to the base portion 101 and/or the top portion 103 at an approximately center point of rack 100. In various embodiments, support 102 can be coupled to base portion 101 and/or top portion 103 at an off-center point of rack 100. In various embodiments, support 102 can have a thickness that is less than a thickness of base portion 101 and/or top portion 103. In other embodiments, support 102 can have a thickness that is approximately equal to a thickness of base portion 101 and/or top portion 103. In various embodiments, support 102 can have one or more grooves in its exterior surface. In some embodiments, a grooved support 102 can be configured to hold and/or support a middle portion of a specimen container 104. In this way, the support 102 can be configured to support the specimen container 104, thereby preventing the specimen container 104 from moving during storage or shipment.

Turning ahead in the drawings, FIG. 1B illustrates a top-down view of the rack 100. In many embodiments, the top portion 103 can be coupled to a top end of support 102 (FIG. 1A). In various embodiments, the top portion 103 can comprise a lock notch 109, a central portion 110, and/or a clip 114. In some embodiments, the lock notch 109 can be configured to allow passage of second portion of a locking mechanism 201 (FIG. 2) through top portion 103 and into a first portion of the locking mechanism 106. In this way, the two portion of the locking mechanism can removably couple, thereby removably coupling lid 200 (FIG. 2) to rack 100.

Various types of clips can be used in a top portion of the rack 100. For example, the clip 110 can be a test tube clip, a clothespin, a pipe clip, a crocodile clip, a u-clip, a binder clip, etc. In further embodiments, the clip 110 can comprise a clip body 112, a clip arm 113, and/or a clip hand 114. In some embodiments, the clip body 112 can be coupled to the central portion 110 and extend out towards an exterior of the rack 100. In many embodiments, the clip arm 113 can be coupled to an outer portion of the clip body 112 and extend in towards the central portion 110. In further embodiments, a gap can exist between the clip body 112 and the clip arm 113. In these embodiments, the gap can allow the clip arm 113 to move and/or flex when the specimen container 104 is inserted into the rack 100. In this way, the clip arm 113 can facilitate safe and gentle insertion of the specimen container 104 into the rack 100, thereby protecting the specimen container 104 from forces that may cause the specimen container 104 to break.

In many embodiments, the clip arm 113 can be coupled to the clip hand 114. In some embodiments, the clip hand 114 can be coupled directly to the central portion 110 and/or the clip body 112. In various embodiments, the clip body 112 can have an indent 115 proximal to the clip hand 114. In this way, the clip hand 114 can move and/or flex when the specimen container 104 is inserted into the rack 100. In this way, the clip hand 114 can facilitate safe and gentle insertion of the specimen container 104 into the rack 100, thereby protecting the specimen container 104 from forces that may cause the specimen container 104 to break. In some embodiments, the clip 111 can comprise two or more clip arms 113 and/or clip hands 114. In these embodiments, two or more indents 115 can create a clip bridge 116 on clip body 112. In these or other embodiments, two or more clip hands 114 can work in tandem to grasp the specimen container 104, thereby preventing it from moving during transit. In many embodiments, the clip body 112 can be coupled to the lock notch 109.

Turning ahead in the drawings, FIG. 2 illustrates an exemplary lid 200. Generally speaking, the lid 200 can be made from a variety of different materials. For example, the lid 200 can be made of metal, wood, plastic, ceramic, and/or some other rigid or semi-rigid material. In many embodiments, the lid 200 can have a cross sectional shape similar to the base portion 101 (FIG. 1A). For example, the lid 200 can have a triangular cross section, a circular cross section, a semi-circular cross section, a square cross section, a rectangular cross section, a rhomboid cross section, a trapezoidal cross section, or any other polygonal cross sections. In this way, the lid 200 can be complementary to the base portion 101 (FIG. 1A), thereby allowing it to fit snugly when placed over portions of the rack 100 (FIG. 1A). In various embodiments, the lid 200 can be configured to enclose the support 102 (FIG. 1A) and/or the top portion 103 (FIG. 1A) within the lid 200. In this way, the lid 200 can protect the specimen container 104 (FIG. 1A) from breakage, tipping, and deleterious elements that may be in the environment. In these or other embodiments, the lid 200 can be configured to rest on the lid rest 107 (FIG. 1) when placed over the support 102 (FIG. 1A) and/or the top portion 103 (FIG. 1A).

In various embodiments, the lid 200 can comprise a second portion of a locking mechanism 201 and/or a handle 202. In some embodiments, the second portion of a locking mechanism 202 can be configured to pass through the lock notch 109 (FIG. 1A) and/or be inserted into the first portion of the locking mechanism 108 (FIG. 1). In further embodiments, a second portion of a locking mechanism 201 can extend out of or be coupled to an inner surface of lid 200. In some embodiments, the second portion of the locking mechanism 202 can comprise a nub, a box, a cube, a hemisphere, a pyramid, or some other 3-dimensional shape that is complementary to first portion of a locking mechanism 108 (FIG. 1A). In this way, when the second portion of a locking mechanism 202 is inserted into the first portion of the locking mechanism 108 (FIG. 1A), the lid 200 can be securely but removably coupled to the rack 100 (FIG. 1A). In various embodiments, the handle 202 can be coupled to a top portion of lid 200. In some embodiments, the handle 202 can be configured to be inserted into and/or complementary to indent 117 (FIG. 3).

Turning ahead in the drawings, FIG. 3 illustrates an exemplary cross-sectional view of a system 300. In many embodiments, the system 300 can comprise the rack 100 and/or the lid 200. As can be seen in FIG. 3, the lid 200 can be configured to enclose portions of the rack 100 within the lid 200 and/or removably coupling with the rack 100. In many embodiments, the indent 117 can be formed on a bottom surface of the base portion 103. In some embodiments, the indent 117 can be configured to receive and/or be complementary to the handle 202 (FIG. 2). Turning ahead in the drawings, FIG. 4 illustrates an exemplary uncoupled system 300. In many embodiments, the system 300 can comprise the rack 100 and/or the lid 200.

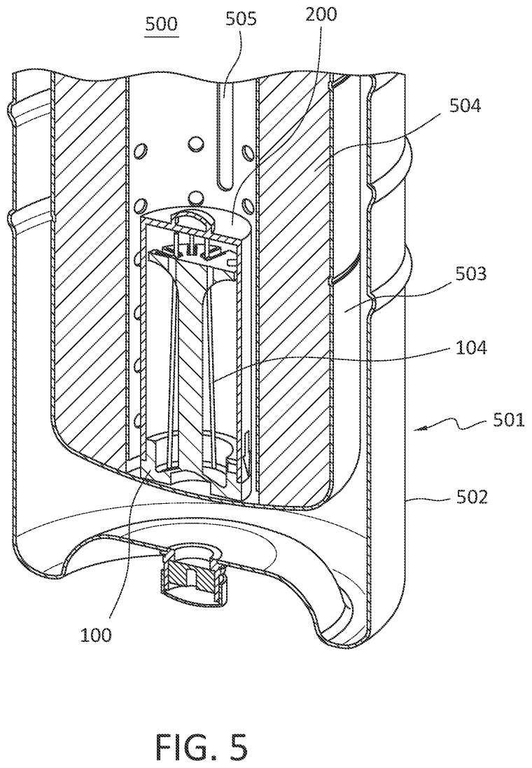

Turning ahead in the drawings, FIG. 5 illustrates an exemplary system 500. In some embodiments, the system 500 can be configured for shipping or transport of the rack 100 and/or the lid 200. In many embodiments, the system 500 can comprise the rack 100, the lid 200, and/or a dewar 501. Generally speaking, the dewar 501 can comprise a vacuum flask used for storing cryogens with boiling points are lower than room temperature (e.g., liquid nitrogen or liquid helium). A variety of different dewars can be used in the system 500. For example, the system 500 can use an open bucket dewar, a dewar with loose-fitting stoppers, or a dewar with self-pressurizing tanks. In some embodiments, the dewar 501 can comprise an exterior wall 502 and/or an interior wall 503. In various embodiments, a vacuum chamber can be disposed between the exterior wall 503 and the interior wall 503. In further embodiments, the dewar 501 can comprise a cryogen and/or a cryogen-saturated media 504. In some embodiments, the rack 100 and/or the lid 200 can be placed inside of the dewar 501 by placing them inside of an inner chamber inward of the inner wall 503. In this way, the rack 100 and/or the lid 200 can be maintained at a sub-zero temperatures, thereby preserving the contents of the specimen container 104.

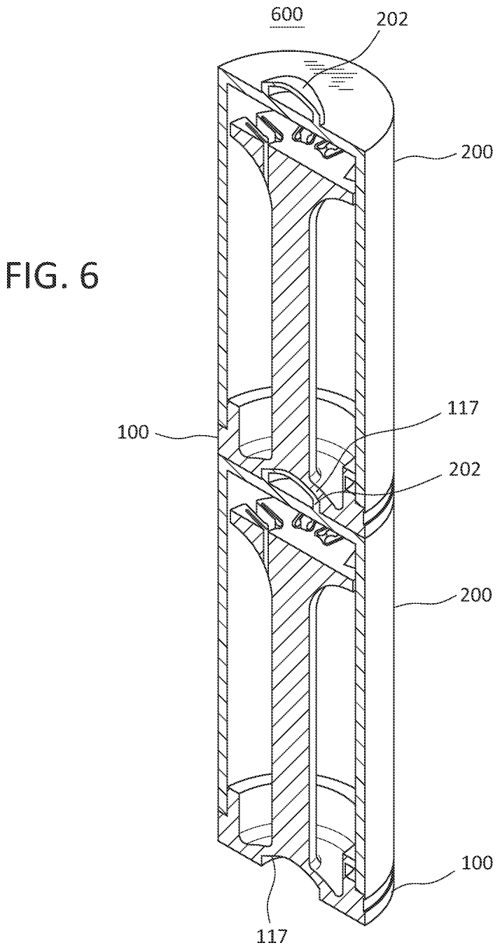

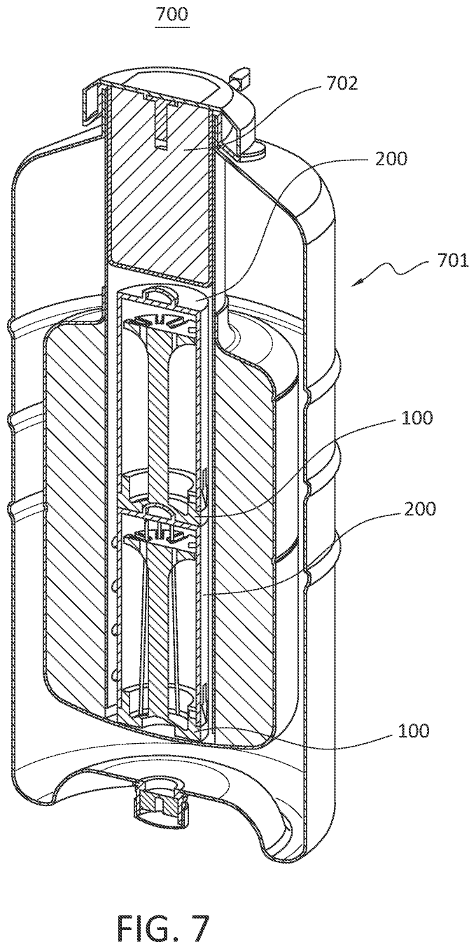

Turning ahead in the drawings, FIG. 6 illustrates an exemplary cross section of a system 600. In many embodiments, the system 600 can comprise a plurality of racks 100 and/or a plurality of lids 200. In some embodiments, the handle 202 can be configured to be inserted into and/or complementary to the indent 117. In this way, the plurality of racks 100 can be stacked one on top of one another for shipment or transport. Turning ahead in the drawings, FIG. 7 illustrates an exemplary cross section of system 700. In many embodiments, the system 700 can comprise a plurality of racks 100, a plurality of lids 200, and a dewar 701. In some embodiments, the dewar 701 can be similar to the dewar 601 (FIG. 6). The dewar 701 may receive a plug 702 for limiting cryogen loss and/or heat transfer.

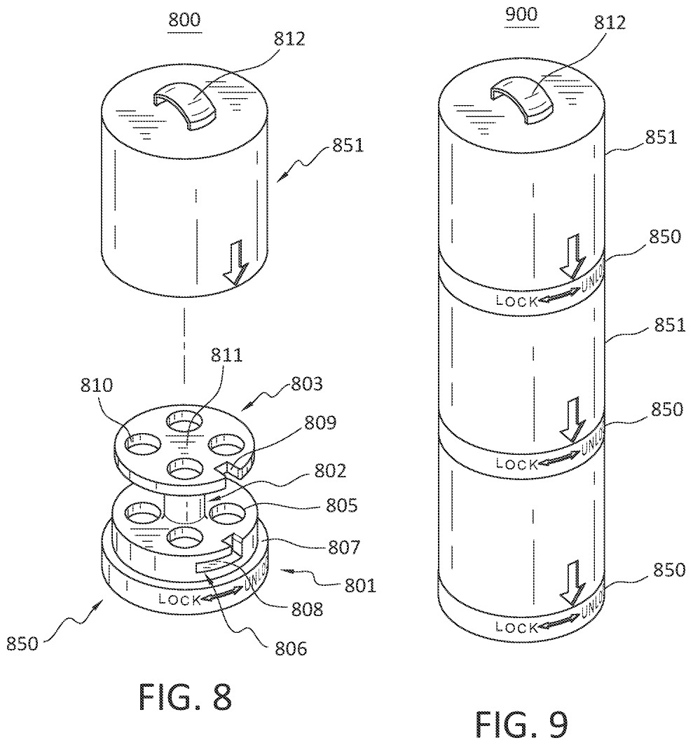

Turning ahead in the drawings, FIG. 8 illustrates an exemplary system 800. In many embodiments, the system 800 can comprise a rack 850 and/or a lid 851. Generally speaking, the rack 850 can be made from a variety of different materials. For example, the rack 850 can be made of metal, wood, plastic, ceramic, and/or some other rigid or semi-rigid material. In many embodiments, the rack 850 can comprise a base portion 801, a support 802, and/or a top portion 803.

In various embodiments, the base portion 801 can be configured to receive a bottom end of a specimen container (not shown). In some embodiments, the base portion 801 can comprise a concavity 805. In further embodiments, the concavity 805 can be located below an upper passage 810. In this way, a bottom end of a specimen container (not shown) can be stopped by the concavity 805 before the bottom end falls off of base portion 801. In many embodiments, the concavity 805 can have a cross section that is circular, rectangular, triangular, or some other shape.

In many embodiments, the base portion 801 can comprise a first portion of a locking mechanism 806 and/or a lid rest 807. In various embodiments, first portion of the locking mechanism 806 can be embedded in, integral with, and/or formed on an outer or an exterior surface of the bottom portion 801. In some embodiments, the first portion of the locking mechanism 806 can be configured to receive a second portion of a locking mechanism (not shown). After the first portion of the locking mechanism 806 has received the second portion of the locking mechanism, a locking action can be performed to removably couple a lid 851 onto rack 850. In this way, the lid 851 can protect a specimen container from breakage, tipping, and deleterious elements that may be in the environment. In various embodiments, the first portion of the locking mechanism 806 can comprise a groove 808 formed on bottom portion 801. In these or other embodiments, the groove 808 is formed on an exterior surface of the bottom portion 801. For example, the groove 808 can be formed on a side exterior surface, and/or a top exterior surface.

In many embodiments, a support 802 can extend from the base portion 801 to a top portion 803. In some embodiments, the support 802 can be coupled to the base portion 801 and/or the top portion 803 at an approximately center point of rack 850. In various embodiments, the support 802 can be coupled to the base portion 801 and/or the top portion 803 at an off-center point of the rack 850. In various embodiments, the support 802 can have a thickness that is less than a thickness of the base portion 801 and/or the top portion 803. In other embodiments, the support 802 can have a thickness that is approximately equal to a thickness of the base portion 801 and/or the top portion 803. In various embodiments, the support 802 can have one or more grooves in its exterior surface. In some embodiments, a grooved support can be configured to hold and/or support a middle portion of a specimen container (not shown). In this way, the support 802 can be configured to support the specimen container (not shown), thereby preventing the specimen container (not shown) from moving during storage or shipment. In various embodiments, the top portion 803 can comprise a lock notch 809, a central portion 811, and/or a upper passage 810. In some embodiments, the lock notch 809 can be configured to allow passage of second portion of a locking mechanism (not shown) through the top portion 803 and into the first portion of the locking mechanism 806. In this way, the two portions of the locking mechanism can removably couple, thereby removably coupling the lid 851 to the rack 850.

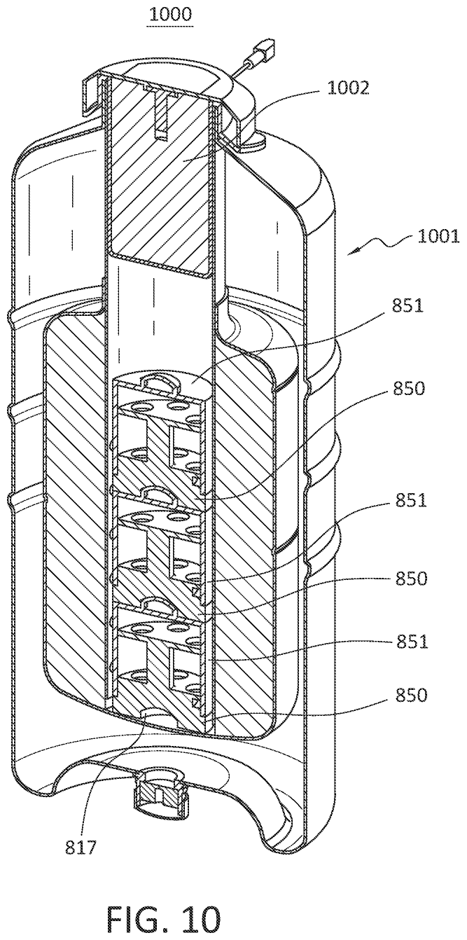

Turning ahead in the drawings, FIG. 9 illustrates a system 900. In many embodiments, the system 900 can comprise a plurality of racks 850 and/or a plurality of lids 851. In some embodiments, a handle 812 can be configured to be inserted into and/or complementary to a indent 817 (FIG. 10). In this way, a plurality of racks 850 can be stacked one on top of one another for shipment or transport. Turning ahead in the drawings, FIG. 10 illustrates an exemplary cross section of a system 1000. In many embodiments, the system 1000 can comprise a plurality of racks 850, a plurality of lids 851, and a dewar 1001. In some embodiments, the dewar 1001 can be similar to the dewar 601 (FIG. 6) in many respects. The dewar 1001 may be configured to receive a plug 1002 for limiting cryogen loss/heat transfer.

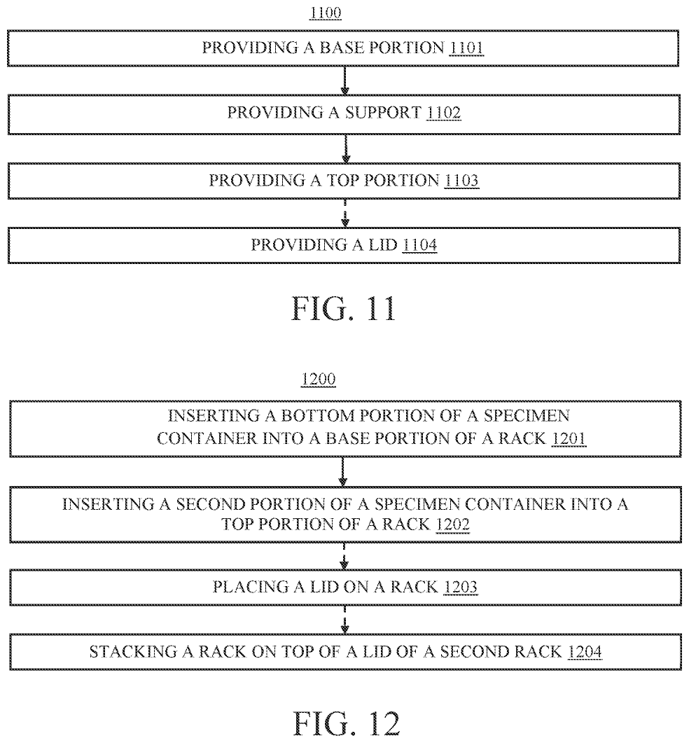

Turning ahead in the drawings, FIG. 11 illustrates a flow chart for a method 1100, according to an embodiment. Method 1100 is merely exemplary and is not limited to the embodiments presented herein. Method 1100 can be employed in many different embodiments or examples not specifically depicted or described herein. In some embodiments, the activities of method 1100 can be performed in the order presented. In other embodiments, the activities of method 1100 can be performed in any suitable order. In still other embodiments, one or more of the activities of method 1100 can be combined or skipped. In many embodiments, method 1100 can comprise providing a base portion (block 1101). The method may include providing a support (block 1102). The method may include providing a top portion (block 1103). The method may also include providing a lid (block 1104).

Turning ahead in the drawings, FIG. 12 illustrates a flow chart for a method 1200, according to an embodiment. Method 1200 is merely exemplary and is not limited to the embodiments presented herein. Method 1200 can be employed in many different embodiments or examples not specifically depicted or described herein. In some embodiments, the activities of method 1200 can be performed in the order presented. In other embodiments, the activities of method 1200 can be performed in any suitable order. In still other embodiments, one or more of the activities of method 1200 can be combined or skipped. In many embodiments, method 1200 includes inserting a bottom portion of a specimen container into a base portion of a rack (block 1201). The method may include inserting a second portion of a specimen container into a top portion of a rack (block 1202). The method may optionally include placing a lid on a rack (block 1203). Moreover, the method may include stacking a rack on top of a lid of a second rack (block 1204).

The terms “first,” “second,” “third,” “fourth,” and the like in the description and in the claims, if any, are used for distinguishing between similar elements and not necessarily for describing a particular sequential or chronological order. It is to be understood that the terms so used are interchangeable under appropriate circumstances such that the embodiments described herein are, for example, capable of operation in sequences other than those illustrated or otherwise described herein. Furthermore, the terms “include,” and “have,” and any variations thereof, are intended to cover a non-exclusive inclusion, such that a process, method, system, article, device, or apparatus that comprises a list of elements is not necessarily limited to those elements, but may include other elements not expressly listed or inherent to such process, method, system, article, device, or apparatus.

The terms “left,” “right,” “front,” “back,” “top,” “bottom,” “over,” “under,” and the like in the description and in the claims, if any, are used for descriptive purposes and not necessarily for describing permanent relative positions. It is to be understood that the terms so used are interchangeable under appropriate circumstances such that the embodiments of the apparatus, methods, and/or articles of manufacture described herein are, for example, capable of operation in other orientations than those illustrated or otherwise described herein.

The terms “couple,” “coupled,” “couples,” “coupling,” and the like should be broadly understood and refer to connecting two or more elements mechanically and/or otherwise. Two or more electrical elements may be electrically coupled together, but not be mechanically or otherwise coupled together. Coupling may be for any length of time, e.g., permanent or semi-permanent or only for an instant. “Electrical coupling” and the like should be broadly understood and include electrical coupling of all types. The absence of the word “removably,” “removable,” and the like near the word “coupled,” and the like does not mean that the coupling, etc. in question is or is not removable.

As defined herein, two or more elements are “integral” if they are comprised of the same piece of material. As defined herein, two or more elements are “non-integral” if each is comprised of a different piece of material.

As defined herein, “approximately” can, in some embodiments, mean within plus or minus ten percent of the stated value. In other embodiments, “approximately” can mean within plus or minus five percent of the stated value. In further embodiments, “approximately” can mean within plus or minus three percent of the stated value. In yet other embodiments, “approximately” can mean within plus or minus one percent of the stated value.

Although specimen container rack and related methods have been described with reference to specific embodiments, it will be understood by those skilled in the art that various changes may be made without departing from the spirit or scope of the disclosure. Accordingly, the disclosure of embodiments is intended to be illustrative of the scope of the disclosure and is not intended to be limiting. It is intended that the scope of the disclosure shall be limited only to the extent required by the appended claims. For example, to one of ordinary skill in the art, it will be readily apparent that any element of FIGS. 1-12 may be modified, and that the foregoing discussion of certain of these embodiments does not necessarily represent a complete description of all possible embodiments. For example, one or more of the procedures, processes, or activities of FIG. 11 may include different procedures, processes, and/or activities and be performed in many different orders.

All elements claimed in any particular claim are essential to the embodiment claimed in that particular claim. Consequently, replacement of one or more claimed elements constitutes reconstruction and not repair. Additionally, benefits, other advantages, and solutions to problems have been described with regard to specific embodiments. The benefits, advantages, solutions to problems, and any element or elements that may cause any benefit, advantage, or solution to occur or become more pronounced, however, are not to be construed as critical, required, or essential features or elements of any or all of the claims, unless such benefits, advantages, solutions, or elements are stated in such claim.

Moreover, embodiments and limitations disclosed herein are not dedicated to the public under the doctrine of dedication if the embodiments and/or limitations: (1) are not expressly claimed in the claims; and (2) are or are potentially equivalents of express elements and/or limitations in the claims under the doctrine of equivalents.

What is claimed is:

1. A rack for a specimen container, the rack comprising:
a base portion configured to receive a bottom end of the specimen container;
a support having a first end coupled to the base portion; and
a top portion coupled to a second end of the support, the top portion configured to receive a second portion of the specimen container extending away from the bottom end of the specimen container.

2. The rack of claim 1, wherein the base portion and the top portion are configured to, after receiving the bottom end of the specimen container and the second portion of the specimen container, respectively, prevent the specimen container from tipping over.

3. The rack of claim 1, wherein the base portion comprises a bowl.

4. The rack of claim 1, wherein the specimen container comprises a biological sample container.

5. The rack of claim 1, wherein the base portion comprises a first portion of a locking mechanism configured to removably couple a lid onto the rack.

6. The rack of claim 5, wherein:
the base portion further comprises a lip around a perimeter of the base portion;
the first portion of the locking mechanism comprises a groove formed on an exterior surface of the lip; and
a second portion of the locking mechanism comprises a nub coupled to an interior surface of the lid.

7. The rack of claim 1, wherein:
the rack further comprises a lid comprising a handle;
the base portion comprises an indent formed on a bottom surface of the base portion; and
the indent is configured to receive the handle, thereby allowing a plurality of racks to be stacked.

8. A method of providing a rack for a specimen container, the method comprising:
providing a base portion of the rack configured to receive a bottom end of the specimen container;
providing a support having a first end coupled to the base portion; and
providing a top portion of the rack coupled to a second end of the support, the top portion configured to receive a second portion of the specimen container extending away from the bottom end of the specimen container.

9. The method of claim 8, wherein the base portion and the top portion are configured to, after receiving the bottom end of the specimen container and the second portion of the specimen container, respectively, prevent the specimen container from tipping over.

10. The method of claim 8, wherein providing the base portion comprises:
providing the base portion comprising a bowl, the base portion configured to receive the bottom end of the specimen container.

11. The method of claim 8, wherein the specimen container comprises a biological sample container.

12. The method of claim 8, wherein providing the base portion comprises:
providing the base portion comprising a first portion of a locking mechanism configured to removably couple a lid onto the rack, the base portion configured to receive a bottom end of the specimen container.

13. The method of claim 12, wherein:
providing the base portion comprises:
providing a lip around a perimeter of the base portion, the base portion configured to receive a bottom end of the specimen container;
the first portion of the locking mechanism comprises a groove formed on an exterior surface of the lip; and
the second portion of the locking mechanism comprises a nub coupled to an interior surface of the lid.

14. The method of claim 8, wherein:
the method further comprises:
providing a lid comprising a handle;
providing the base portion comprises:
providing the base portion comprising an indent formed on a bottom surface of the base portion, the base portion configured to receive the bottom end of the specimen container; and
the indent is configured to receive the handle, thereby allowing a plurality of racks to be stacked.

15. A method of using a rack for a specimen container, the method comprising:
inserting a bottom portion of the specimen container into a base portion of the rack;
inserting a second portion of the specimen container extending away from the bottom end of the specimen container into a top portion of the rack, wherein:
the base portion is coupled to a first end of a support; and
the top portion is coupled to a second end of the support.

16. The method of claim 15, wherein the base portion and the top portion are configured to, after receiving the bottom end of the specimen container and the second portion of the specimen container, respectively, prevent the specimen container from tipping over.

17. The method of claim 15, wherein the specimen container comprises a biological sample container.

18. The method of claim 15, wherein inserting the second portion of the specimen container into the top portion of the rack comprises:
inserting the second portion of the specimen container into a clip coupled to the top portion of the rack.

19. The method of claim 15, wherein:
the base portion comprises:
a first portion of a locking mechanism; and
the method further comprises:
after inserting the bottom portion of the specimen container and the second portion of the specimen container into the rack, coupling the first portion of the locking mechanism to a second portion of the locking mechanism coupled to a lid.

20. The method of claim 15, wherein:
the base portion comprises an indent formed on a bottom surface of the base portion; and
the method further comprises:
placing the rack on top of a second rack for a second specimen container by inserting a handle of a lid of the second rack into the indent of the base portion.
